(19) United States
(12) Patent Application Publication
(10) Pub. No.: US 2006/0165866 A1
(43) Pub. Date: Jul. 27, 2006

(54) Instant food

(76) Inventors: Hitoshi Furuta, Osaka (JP); Yoko Sato, Tokyo (JP); Takeshi Tomio, Tokyo (JP); Hirokazu Asano, Tokyo (JP); Kiyohito Suzuki, Tokyo (JP)

Correspondence Address: PAUL AND PAUL, 2000 MARKET STREET, SUITE 2900, PHILADELPHIA, PA, 19103, US

(21) Appl. No.: 10/525,085

(22) PCT Filed: Aug. 21, 2003
(86) PCT No.: PCT/JP03/10619

§ 371 Date: Feb. 22, 2005

(30) Foreign Application Priority Data
Aug. 23, 2002 (JP) 2002-242977

(51) Int. Cl. A23L 1/40

(52) U.S. Cl. 426/589

(57) ABSTRACT

Legume-derived, and particularly soybean-derived, water-soluble polysaccharides are added to thickener-containing powder supplied with an instant food to prevent clumping of powder masses during reconstitution and for a more homogeneous reconstitution. Thus, the problem is solved which is encountered with soup powders such as a thickened soup powder and a curry-seasoned soup powder, which are supplied with instant foods such as instant noodles, containing thickeners such as starch or gum substances to impart thickness, whereby reconstitution in a stationary state produces swelling of the thickener and prevents adequate dispersion, resulting in scattering of powder masses in the soup and clumping at the bottom of the container and, thereby, impairing the taste.

### FIELD OF THE INVENTION

The present invention relates to an instant food comprising a thickener-containing powder.

### BACKGROUND ART

Instant foods such as instant noodles are packaged with powdered seasonings for preparation of starch sauce soups or curry soups. In the case of powdered instant soups, cup soups and the like, such products can be fully prepared by adding hot water either after transferring the powder to a separate cup or using the cup provided with the product, or else adding water and heating the mixture in a microwave oven.

In most cases, the powders contain various thickening agents such as starches or gums for the purpose of imparting a heat-insulating effect or thickness. Such instant foods are usually packaged in a container serving as both the reconstituting vessel and the serving bowl; however, often the food is not suited for stirring after addition of the hot water, or it may be necessary to allow the food to stand for several minutes without stirring after microwave heating, such that in many cases the food remains reconstituted, and in a stationary state, until consumption. When the instant food is prepared in a stationary state, the thickener in the seasoning tends to swell and this results in insufficient dispersion, producing powder masses which become scattered in the soup or clump at the bottom of the container, thereby impairing the taste.

Japanese Unexamined Patent Publication No. 11-290000 discloses a method of dispersing a starch-containing powdered food, but the effect thereof is inadequate and the method has not satisfactorily solved the problems encountered with stationary reconstitution of most instant noodles or cup soups.

Also, Japanese Unexamined Patent Publication No. 9-289880 discloses a method of reacting soybean polysaccharides with starch foods to reduce the viscosity of the gelatinized starch of starch-containing foods, to prevent the gelling which occurs after cooling, but this disclosure only describes the various effects of heating and cooling on starch solutions and does not deal with solving the aforementioned problem encountered with instant foods.

### DISCLOSURE OF THE INVENTION

It is an object of the present invention to prevent the clumping of an instant food, packaged with a thickener-containing powder, which occurs when it is reconstituted, in order to achieve uniform reconstitution of the powder.

As a result of much diligent research on the problem described above, the present inventors completed this invention after discovering that it is effective to add legume-derived, and particularly soybean-derived, water-soluble polysaccharides to powders supplied with instant foods.

Specifically, the present invention provides an instant food comprising a powder which contains a mixture of both a thickener and legume-derived water-soluble polysaccharides. The thickener may be starch, and the water-soluble polysaccharides used are preferably ones derived from soybean. The instant food is particularly useful when applied for a food packaged with a container serving as both the reconstitution vessel and the serving bowl.

### BEST MODE FOR CARRYING OUT THE INVENTION

The thickener used may be a food containing wheat flour, rice flour, or potato, azuki bean, pea or arrowroot starch, or various modified forms of wheat starch or potato starch, or a gum substance such as dextrin, guar gum or xanthan gum. The amount will differ depending on the type of instant food, the container volume, and the types and amounts of seasonings.

The water-soluble polysaccharides used for the invention is derived from legumes, and various legumes including soybean, azuki bean, green peas, horse bean, kidney bean and the like may be used as polysaccharide sources according to the invention, although using soybean as the source is particularly advantageous because soybean is produced in large amounts and is readily available in the form of okara. The soybean is most preferably cotyledonous.

The water-soluble polysaccharides may be of any molecular weight, but it preferably has an average molecular weight of from a several thousand to a several million, and most preferably between 5000 and 1 million. If the molecular weight is too high the viscosity will be excessively increased, and the water-soluble polysaccharides will be responsible for an increased viscosity of the soup when boiling water is poured into the instant food or the food is heated in a microwave oven, thereby making it impossible to achieve an adequate effect. Throughout the present specification, the average molecular weight of the water-soluble polysaccharides is the value determined by the limiting viscosity method wherein the viscosity is measured in a 0.1 M NaNO₃ solution using standard pullulan (product of Showa Denko K.K.) as the standard substance, while the uronic acid is measured by the Blumenkrantz method.

The water-soluble polysaccharides may be obtained by water extraction from a polysaccharide-containing raw material or, if necessary, by heated elution under acidic or alkaline conditions, or it may be eluted by decomposition with an enzyme. The method applied to production of the legume-derived water-soluble polysaccharides may be any publicly known method, an example of which is described below.

In the case of soybean, for example, the okara by-product from production of tofu, soy milk or separated soybean protein may be utilized.

The raw material may be subjected to hot extraction under acidic or alkaline conditions, preferably at a pH near the isoelectric point of each protein, and preferably at 80° C. or higher and more preferably from 100-130° C. to separate out the water-soluble fraction, and then either dried directly or dried after removal of the hydrophobic substances or low molecular weight substances by, for example, activated carbon treatment, resin adsorption treatment or ethanol precipitation treatment, to obtain water-soluble hemicellulose. The water-soluble polysaccharide extracted in this manner preferably comprises uronic acid at 5-50% and, more preferably, at 5-40%.

The amount of water-soluble polysaccharides used is not particularly restricted, and may be 0.01-10.0%, preferably 0.05-5.0% and more preferably 0.1-2.0% with respect to the thickener included in the powder of the instant food. If the content is too high, an effect of an increased viscosity of the prepared powder-reconstituted solution will not be adequate, while if it is too low, it will be difficult to achieve an effect of uniform reconstitution in a stationary state.

The powder of the instant food may additionally contain various publicly known powder emulsifiers, inorganic substances such as silicon oxide, or stabilizers and the like which are commonly used in instant foods, and it may also contain various powdered extracts, spices, flavorings, fats and oils, gustatory additives, seasonings, coloring agents and the like.

The instant food itself will typically be dry noodles or instant soup, but may be any type of dry food including various types of agricultural products, livestock products or marine products, either in powdered or granular form. Such instant foods may be packaged in a container serving as both the reconstituting vessel and the serving bowl, and the powdered portion may be sealed in a plastic bag if desired.

### EXAMPLES

Preferred embodiment of the invention will now be explained through examples, with the understanding that the invention is not limited to these examples. Unless otherwise specified, the parts and percentage values in the examples are based on weight.

### Example 1

### Preparation of Water-Soluble Polysaccharides

Distilled water was added in a 3-fold amount to okara (20% solid portion) obtained as a by-product during the production of isolated soybean protein using defatted soybean and, after adjusting the pH to 4.5 with hydrochloric acid, the mixture was heated at 120° C. for 90 minutes for extraction of the water-soluble polysaccharides. The extraction was followed by centrifugation (1000 G×20 min) for separation of the supernatant containing the water-soluble polysaccharides. The separated supernatant was subjected to granular activated carbon column treatment, and after purification was spray dried. Analysis of the water-soluble polysaccharides obtained in this manner yielded a viscosity-average molecular weight of about 150,000 and a uronic acid content of 18%.

### Example 2

A commercially available instant noodle product packaged with sauce and container was purchased, and the two different powdered curry seasonings listed in the following table were prepared for use in place of the sauce, to produce instant foods having the powdered seasonings laid over instant cup noodles at a rate of 13 g with respect to 100 g of the instant noodles. (The soybean water-soluble polysaccharides shown in the table was the same as in Example 1.) When 300 g of hot water was poured over the food and the mixture was allowed to stand for 3 minutes, and the state of the soup was examined, an obvious difference was noticed in terms of generation of masses and uniformity of thickness.

TABLE 1

| Ingredients (pts. by wt.) | Example 2 | Comp. Ex. 1 |
|---|---|---|
| Potato starch | 20.0 | 20.0 |
| Salt | 17.0 | 17.0 |
| Curry powder | 5.0 | 5.0 |
| Beef extract powder | 12.0 | 12.0 |
| Powdered vegetable | 4.0 | 4.0 |
| Food coloring | 0.4 | 0.4 |
| Water-soluble soybean | 0.2 | — |
| polysaccharides | | |

State after reconstitution

| | | |
|---|---|---|
| Powder masses | Virtually none | Notable |
| Viscosity | Uniform thickness | Non-uniform thickness |

### Example 3

An instant food was prepared by placing 3 g of freeze-dried corn grains and 20 g of the powdered corn potage soup shown in Table 2 into a 250 ml container. After pouring 150 g of hot water over the food and stirring 5 times with a spoon, the mixture was allowed to stand for 2 minutes, and the state was observed. The generation of masses and uniformity of thickness of this food product was clearly superior to that of the comparison food product.

TABLE 2

| Ingredients (pts. by wt.) | Example 2 | Comp. Ex. 1 |
|---|---|---|
| Corn powder | 10.0 | 10.0 |
| Potato starch | 21.0 | 21.0 |
| Skim milk powder | 5.0 | 5.0 |
| Lactose | 25.0 | 25.0 |
| Salt | 4.0 | 4.0 |
| Dextrin | 9.0 | 9.0 |
| Monosodium glutamate | 2.5 | 2.5 |
| Powdered food oil | 2.0 | 2.0 |
| Spice | dash | dash |
| Coloring agent | dash | dash |
| Edible vegetable oil | 10.0 | 10.0 |
| Water-soluble soybean | | 0.2 |
| polysaccharides | | |

State after preparation

| | | |
|---|---|---|
| Powder masses | Virtually none | Notable |
| Viscosity | Uniform thickness | Non-uniform thickness |

### INDUSTRIAL APPLICABILITY

The results described above demonstrate that thickener-containing powder with an added water-soluble polysaccharides can contribute to preparation of an instant food with satisfactory reconstitutability even with stationary preparation and minimal stirring.

1. An instant food comprising a powder which contains a mixture of both a thickener and legume-derived water-soluble polysaccharides, the instant food being reconstitutable by addition of hot water to the instant food.

2. (canceled)

3. An instant food according to claim 1, wherein the legume is soybean.

4. An instant food according to claim 1, wherein the instant food is packaged with a container which serves as both a reconstituting vessel and a serving bowl.
